(19) United States
(12) Patent Application Publication
(10) Pub. No.: US 2018/0128132 A1
(43) Pub. Date: May 10, 2018

(54) Two-stroke internal combustion engine

(71) Applicant: Cesar Mercier, Roseland, NJ (US)

(72) Inventor: Cesar Mercier, Roseland, NJ (US)

(21) Appl. No.: 15/610,809

(22) Filed: Jun. 1, 2017

Related U.S. Application Data
(60) Provisional application No. 62/343,936, filed on Jun. 1, 2016.

(51) Int. Cl. F01L 1/18; F02B 75/02; F02B 75/30; F01L 1/46

(52) U.S. Cl. CPC F01L 1/18; F02B 75/02; F02B 2075/025; F01L 1/462; F02B 75/30

(57) ABSTRACT

A cam and follower apparatus adapted to translate the force of a piston to turn the shaft of an engine. The cam profile is made of three intersecting circles allowing for one follower to be near top dead center while another follower is near bottom dead center. The surface of the follower is a circle which shares the same center point and radius with the circles of the cam profile. The surface of the follower also closely intersects the axis of the follower preventing the follower from spinning like a roller follower. The follower can therefore spread the force from the piston to a wider area on the cam for longevity.

This invention relates generally to the method or an apparatus for converting linear motion into rotational motion using cams and followers, suitable for use in a rotary engine. This invention relates to a balanced engine that uses a special Cam and Follower configuration to achieve maximum torque and durability. This engine also relates to a float-less valve and cam configuration that can be screwed to an internal combustion engine.

### BACKGROUND OF THE INVENTION

Engineers have been trying to find efficient ways to convert reciprocal motion into rotary motion ever since the creation of the first internal combustion engine. Such a solution will help to design a new engine that can consume petroleum fuel more efficiently. My new engine will allow manufacturers to build new engines that are smaller, lighter, more efficient, powerful and durable.

### BRIEF SUMMARY OF THE INVENTION

This engine operates similarly to a conventional two-cycle engine, but the similarity stops there. This engine uses a new cam and follower configuration while balancing the action and reaction forces produced during operation. This cam and follower setup allows for greater surface contact between the cam and follower in order to transfer the force of the piston safely to the cam for a long time. This engine uses both action and reaction forces of the combustion event to produce more power. This results in an engine that is recoil-less since the reaction torque has been used towards production of more power. This engine uses hydraulics to distribute forces in all directions, which prevents the engine from shaking the engine mounts. This engine also features a shape charged combustion chamber. This engine is designed with load balancing, redundancy and fault tolerance. This engine features a relatively constant torque production. In optional configuration, this engine features a float-less valve and cam assembly that can be screwed in for ease of installation and maintenance.

### SUMMARY OF THE INVENTION

It is an object of this invention to provide a two-stroke engine with a lubrication system which does not require oil to be pre-mixed with the fuel in order to lubricate its moving components.

It is another object of this invention to provide a two-stroke engine with rear compression, other than that of the crankcase.

It is another object of this invention to provide a two-stroke engine where the piston skirt does not brush against the cylinder walls due to throws of the rods.

It is another object of this invention to provide an engine module where a piston operating within a cylinder pushes on a piston seat component that rides on rails mounted on the piston block to prevent the piston from brushing against the cylinder.

It is another object of this invention to provide a modular two-stroke engine that can be combined to form a variety of shapes, not limited to radial engine configuration, V shape or flat in-line cylinder configuration, sharing a crank case.

It is another object of this invention to provide a two-stroke engine that does not need an exhaust expansion chamber to prevent fresh fuel and air mixture from leaving the combustion chamber.

It is another object of this invention to provide a two-stroke engine with a screw-in intake float-less valve assembly and valve Cam.

It is another object of this invention to provide a configuration of cam and follower assembly that allows for a large section of the follower's face to be in constant contact with the cam from a TDC position and back, to distribute impact forces for durability.

It is another object of this invention to provide a two-stroke engine with a 360 degree oil pickup.

It is another object of this invention to provide an engine with substantially no recoil.

It is another object of this invention to provide a two-stroke engine with dynamic spark advance feature not controlled by electronics.

It is another object of this invention to provide a two-stroke without reed valves.

It is another object of this invention to provide a two-stroke engine that is easy to manufacturer with straight holes and simple shapes that can be mass produced without the need for sand mold casting.

The present two-stroke engine does not require oil to be mixed with engine fuel/air mixture in order to lubricate moving components. The lubrication system is identical to that of a four-stroke engine whereas an oil pump is used to suck oil from an oil sump to lubricate all moving parts. The present two-stroke engine has a rear compression chamber where at least some part of the charge is compressed by the engine working piston in a volume other than that of the engine crankcase. The present two-stroke engine uses simple transfer ports and or holes within the cylinder to deliver fresh charge to the combustion chamber. These simple passages allow for ease of manufacturing. The present two-stroke engine uses screw-in intake valve to ease manufacturing, troubleshooting and repair. The present engine uses a float-less valve to support very high RPM operations.

The preferred embodiment uses a plurality of exhaust ports near bottom dead center, allowing manufacturers to retrieve maximum torque or horsepower. Wide and short exhaust ports allows for higher compression ratio and torque, while wide and tall exhaust ports allows for higher speed and horsepower. The present engine has a rotatable oil pickup head that allows oil to be picked up by the oil pump during hard cornering. The oil suction head moves with the oil due to gravity and centrifugal forces.

The present engine is a two-stroke engine comprising: a stationary cylinder and engine block, at least one transfer port, a movable piston functioning within the said cylinder forming a combustion chamber, a stationary piston functioning within the said movable piston, forming a rear compression chamber, a cam and follower, a movable piston seat which supports at least one follower component is adapted to link the movable piston to the cam which is fixed to a flywheel producing power directly or via gears, wherein at least one top port is located near the crown of the movable piston, and wherein at least one bottom port is located near bottom of the movable piston skirt, wherein the said at least one bottom port is open to allow fresh fuel/air mixture to enter the rear compression chamber to be compressed when the movable piston is near Top Dead Center, wherein the at least one top port is open when the movable piston is near Bottom Dead Center to push the compressed air or air/fuel mixture through the transfer ports and/or inlet valve into the combustion chamber, wherein the fuel mixture is ignited during compression stroke to push the piston down during power stroke, wherein exhaust leaves the combustion chamber through exhaust ports located in the cylinder near bottom dead center. At least one two-stroke conventional transfer port may be used in conjunction or in lieu of at least one intake valve.

In another embodiment, the engine has at least one intake valve near top dead center, and is actuated by a valve cam and rocker, wherein the intake valve assembly is screwed into the combustion chamber to ease manufacturing process, troubleshooting and repair.

The present engine has a mechanism for transferring side thrust motion of the piston onto a piston seat which rides like a train on rails mounted on the engine block. The piston seat is a multi-function one piece component made with bearing materials to glide on the engine block directly or indirectly. The piston seat may be made of other materials by mounting another bearing on the seat to glide against another bearing on the engine block or on the engine block itself.

The present engine has a hydraulic pump comprising: a bearing mounted on a piston seat, a bearing mounted on engine block, at least one check valve, wherein the bearing mounted on the piston seat and the bearing mounted on the engine block form a closed cylinder with a cavity leading to at least one check valve, wherein the piston seat moves with the piston to expand and contract the volume within the said closed cylinder, wherein the at least one check valve is used to allow oil to be sucked in the cylinder during expansion, and to allow oil to be pushed out to another channel during contraction of the volume within the closed cylinder.

The present engine has an oil sump system that allows oil to be sucked into an oil pump regardless in a 360 degree fashion. The oil sump is substantially cylindrical. A rotatable suction head component is adapted to move with the oil by gravity.

The present engine uses two pistons per combustion chambers. Each piston is attached to a follower, translating reciprocal motions into rotational motion. During power stroke, each piston from this combustion chamber pushes on a different cam which is turning in opposite direction. Each cam is mounted on a separate flywheel which turns a pinion shaft via transmission gears. Therefore both actions and reaction of the combustion event is used equally to spin the shaft. Furthermore, this engine is made of another combustion chamber comprises of an additional two opposed pistons. These two pistons share the same cams and flywheels adding more power to the shaft when the first combustion chamber is at compression stroke. This substantially produces a constant line of torque during the engine cycle. Since the forces of the combustion event equally do work on opposite sides of the engine, no reactive torque is left to produce recoil.

### BRIEF DESCRIPTION OF THE DRAWINGS

FIG. 1A shows a configuration for cam curve and follower travel location to achieve optimum torque and horsepower per size ratio, using a large follower surface area to distribute the force to the cam curve.

FIG. 1B shows a detailed view of the cam and follower configuration that is suitable for achieving optimum power to size ratio for an engine, and the use of forced hydraulics between the cam and the follower in a direction to increase torque and durability.

FIG. 2A shows a side view of an engine module which can be multiplied and combined to form a bigger engine. The piston assembly in this figure is set at about top dead center (TDC).

FIG. 2B shows a section view of the engine module comprising.

FIG. 2C shows a detailed section view of the engine module.

FIG. 3A shows a bottom view of the engine module.

FIG. 3B shows a side section view of the engine module.

FIG. 3C shows a detailed side section view of the engine module.

FIG. 4A shows a side view of the engine module with its piston assembly set a about BDC.

FIG. 4B shows a top section view of the engine module with its piston assembly set at about BDC.

FIG. 4C shows a detailed top section view of the piston assembly at about BDC.

FIG. 4D shows a detailed top section view of the piston assembly, displaying the follower locking mechanism.

FIG. 5A shows an isometric view of the engine module, displaying the piston assembly at about TDC.

FIG. 5B shows an exploded view of the engine module.

FIG. 6A shows an exploded view of the piston assembly.

FIG. 6B shows an isometric view of the piston assembly with its adjacent surface bearings open to display inner features.

FIG. 7A shows a plurality of piston assemblies being inserted into an engine block.

FIG. 7B shows a detailed view of hydraulic valve insertion and bearing locking mechanism.

FIG. 8A is an exploded view of the rotary engine designed without air valves on the block.

FIG. 8B is a detailed view of an oil pump carved unto the shaft.

FIG. 8C is a detailed view of the engine module mounted in the engine block in a working position.

FIG. 9A shows a front view of a rotary engine comprising a plurality of engine module.

FIG. 9B shows a section front view of a rotary engine consisted of 4 engine modules opposing each other, and forming a 2 combustion chambers (the one on top is at TDC and the other at BDC respectively).

FIG. 10A shows a top view of the rotary engine comprising a plurality of engine modules.

FIG. 10B shows a front section view of the rotary engine showing two opposed engine modules forming a balanced combustion chamber with the pistons at about BDC.

FIG. 100 shows a front section of the rotary engine showing two opposed engine modules forming a balanced combustion chamber with the pistons at about TDC.

FIG. 11A is a front view of the rotary engine showing oil cap 42 near bottom to prevent oil over fill.

FIG. 11B is a side section view of the rotary engine, displaying a center view of the inner components and oil passages

FIG. 11C is a side section view of the rotary engine, displaying oil passages from one side of the engine module to the other.

FIG. 12 is an exploded view of a float-less valve assembly along with a valve cam.

FIG. 13A is a top view of the rotary engine with valve assembly installed.

FIG. 13B is a section view of the rotary engine with its valve assemblies.

FIG. 13C is a detailed view of the valve assembly mounted in a working position.

FIG. 13D is a section detail view of the valve assembly mounted in a working position.

FIG. 14 is an exploded view of the rotary engine showing a 360 degree oil pickup head within the case.

### REFERENCE NUMERALS

### Number Description

21 Engine block
22 Movable piston
23 Stationary piston
24 Movable piston seat
25 Follower component
26 Cam component
27 Flywheel supporting the cam component.
28 Axle for the flywheels
29 Axle Nut
30 Cotter pin to lock the axle nut.
31 Cylinder Liner
36 Follower Ball Bearing
37 Follower Seat Bearing
38 Follower Bushing
40 Piston Seat Action Bearing
41 Piston Seat Reaction Bearing
42 Oil Cap
43 Shaft Support
44 Cylinder Bottom
45 Shaft Cover
46 Shaft
47 Oil Pump
48 Shaft Bearing in Shaft Support
49 Shaft Bearing in engine Block
50 Rotatable oil pickup Head
51 Stationary oil Distribution Housing
52 Oil pickup head Spring
53 Oil Sump Drain Screw
54 Hydraulic pump Block Bearing
55 Hydraulic Check Valve
56 Piston Seat Hydraulic Bearing
57 Center block Bearing
58 Hydraulic pump block bearing Lock Key
59 Sparkplug
60 Engine Cover
61 Oil Sump
62 Oil Fitting
63 Axle Bearing
70 Action Rail Bearing
71 Reaction Rail Bearing
72 Cylinder Valve Body
73 Rocker
74 Cylinder Valve Nut
75 Cylinder Valve Cam Hook
76 Cylinder Valve Split Key
77 Cylinder Valve Spring Retainer
78 Cylinder Valve Spring
79 Cylinder Valve Body Lock Key
80 Valve Cam
81 Cylinder Valve

### DETAILED DESCRIPTION OF THE PREFERRED EMBODIMENTS

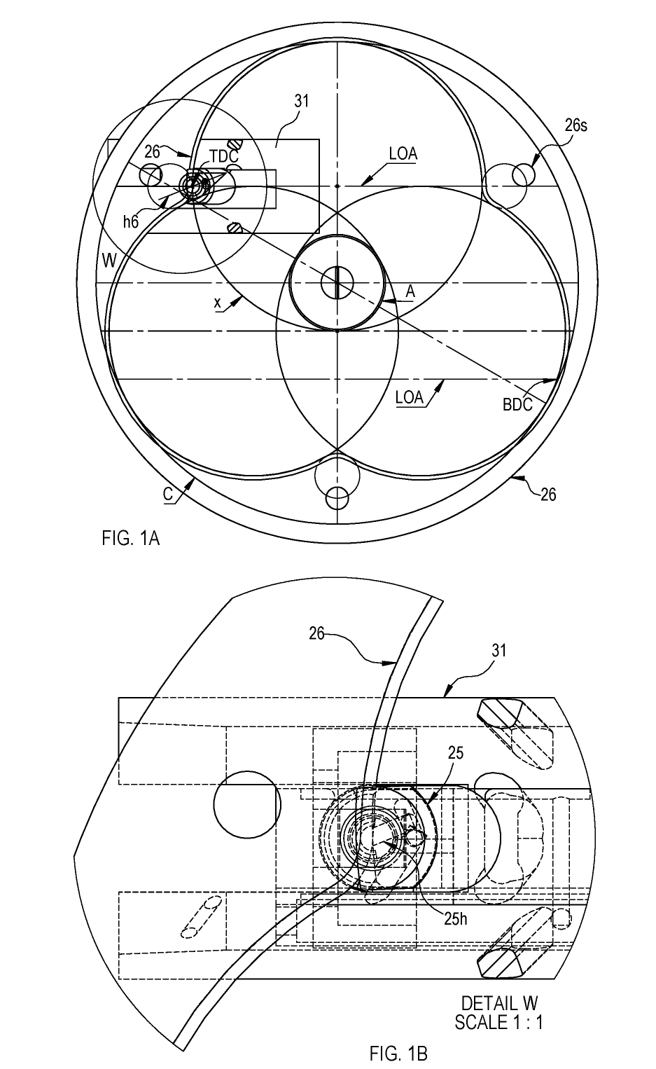

A preferred method or setup for translating reciprocating motion into rotary motion using a cam and follower mechanism to achieve maximum torque and power per size ratio will now be described. The cam profile 26 of FIG. 1A is made of a plurality of intersecting circles X, that are curved at their intersections to form a smooth endless groove or of peaks and valleys cam profile. The Line Of Action (LOA) perpendicularly intersects the cam profile near Top Dead Center (TDC), to efficiently translate the combustion force into rotary motion. The center circle A is tangent to the intersecting circles X. The diameter of circle X is about 3 times the diameter of circle A, which is about the dimension of the moment arm length. Near Bottom Dead Center (BDC) the circle C intersects the X circles. A basic formula can be used as follows: X=A x 3. Using this three circle cam profile, we are able to have one follower 25 pushing on a cam 26 near top dead center TDC, while another follower pushing on the cam near bottom dead center BDC.

A follower 25 of FIG. 1B, is adapted to push on cam profile 26 at about LOA. Follower 25 pivots back and forth on its own axis; however the contact face of the follower is round to match circle X of the cam profile. The contact face of the follower intersects near the axis of the follower. This causes the follower to not turn all the way around its own axis like a roller, but to follow the cam profile. Contrary to other cam and follower configurations, this design provides a large surface area on the follower to be in constant contact with the cam profile to distribute the load and the forces involved from TDC and back. This configuration also allows for hydraulic fluids h6 to be pushed in between the adjacent surfaces of the cam and follower as illustrated in 25h. This functions like a hydraulic bearing, increasing the durability of the components. The direction of the fluid force h6 also adds to the torque output of the cam. The surface contact area of the follower is substantially positioned normal to that of the cam near TDC. Number 31 of FIG. 1B shows a cylinder of an internal combustion engine adapted to use this cam and follower configuration.

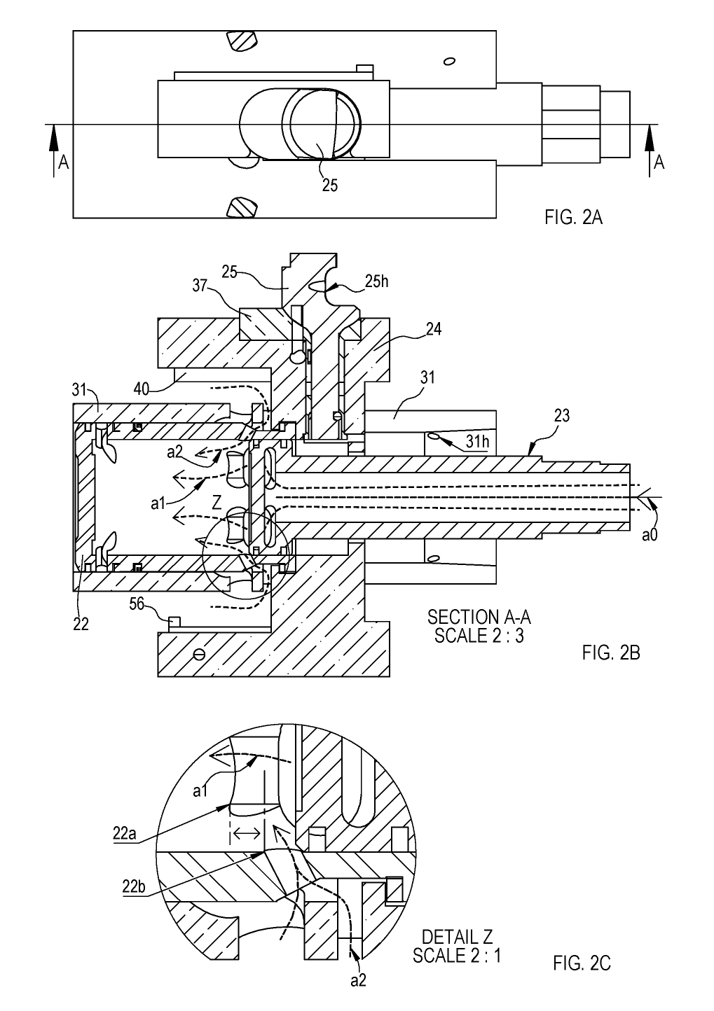

FIG. 2A is a side view of an engine module adapted to use follower 25.

FIG. 2B is a side section view of the engine module. This engine module is made of a cylinder Liner 31 or a cylinder in an engine block, a movable piston 22 reciprocating within cylinder 31, a stationary piston 23 operating within piston 22. Piston 22 sits on a piston seat 24 witch supports follower 25. A follower bearing 37 is used to lessen friction between seat 24 and follower 25. Bearing 56 on one side of the piston seat is used to force hydraulic fluid underneath bearing 40. Oil passages within bearing 40, seat 24, bearing 37 and follower 25 allows for hydraulic fluid to be pushed through exit 25h as h6. Oil passages 31h are fed by a lower oil pressure engine pump, and are used to squirt oil to the piston skirts and rings. As you can see, all moving parts so far are lubricated. The air intake flow a0 travels within the stationary piston 23 to enter the compression chamber underneath movable piston 22 as flow a1. Other air flow a2 enters the compression chamber from other passages on the side of the piston skirt.

FIG. 2C is a detailed section view of the engine module which outlines the order of air intakes entering into the compression chamber. Intake port 22a is a cavity within the piston skirt which is adapted to allow air flow a0 to enter the compression chamber. Secondary intake port 22b is a cavity on the piston skirt, but this one is placed lower to allow air flow a1 to enter the compression chamber first before air flow a2. As piston 22 rises towards TDC, a vacuum is created in the chamber underneath piston 22. When piston 22 is at about TDC, port 22a is open to allow air flow a0 to rush in as a1. If the throttle of the engine is wide open, the charge from the throttle body will fill up the compression chamber. However, if the throttle body of the engine is not fully open, a partial vacuum will still remain within the compression chamber. As piston 22 continues to rise, secondary port 22b will be open to fill the partial vacuum. In this preferred embodiment, the port 22b draws air flow a2 from within the engine case. A bypass air passage in the engine case serves as a positive crankcase ventilation system. In a scenario where the engine is running at idle, fresh air a2 is sucked in to be mixed with the idle charge from the throttle to fill the compression chamber with a fully oxygenated leaner mixture. In a scenario where the throttle body is fully open, no more vacuum is left in the compression chamber, therefore no more fresh air a2 is sucked into the compression chamber, which is now full with a richer mixture to produce more power. In a scenario where the throttle body is partially open, a partial vacuum is created in the compression chamber and is used to partially suck in fresh air a2 to fill the compression chamber with a partial rich mixture. These two air intake management system allows for advanced setup with dual throttle body, dual fuel systems with fuel select capabilities. In a scenario where gas fuel like propane is available in addition to a liquid fuel like gasoline, the operator can decide which fuel to be metered first to enter the compression chamber. This allows for greater flexibility when in remote areas.

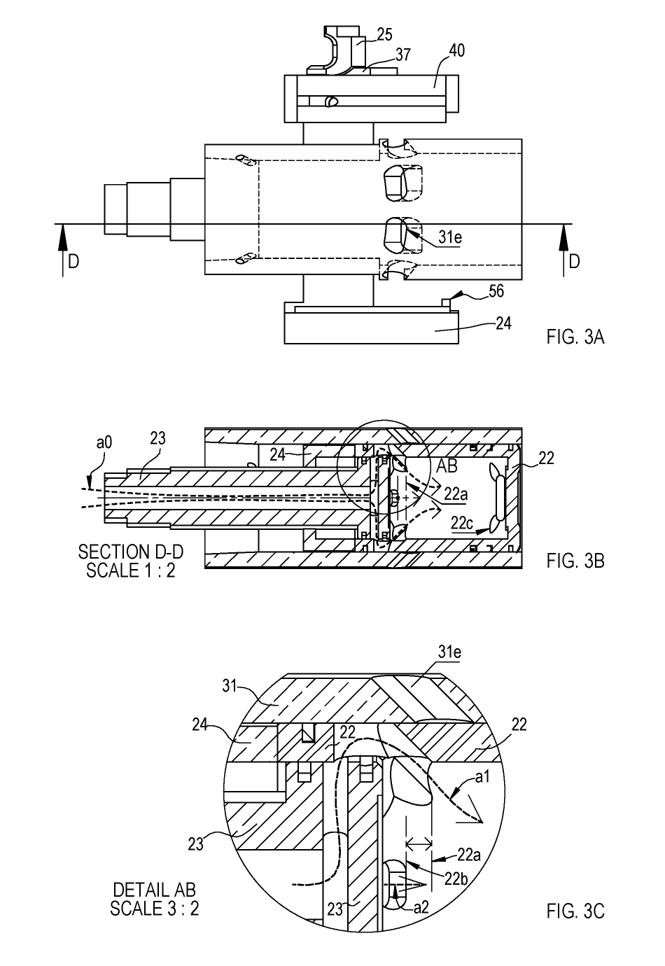

FIG. 3A is a bottom view of the engine module showing the action bearing 40, the follower 25, the follower bearing 37, the hydraulic bearing 56, the piston seat 24 and the exhaust ports 31e. The piston seat has two arms: one supporting the follower 25, the other arm houses the hydraulic bearing and adapted to oppose forces from the follower, resulting in a balanced piston seat.

FIG. 3B is a bottom section view of the engine module showing the air intake flow a0 going through the stationary piston 23 and is split at the top to enter the compression chamber through ports 22a. A transfer port 22c is located substantially near the piston crown 22. Piston 22 sits on piston seat 24. This configuration also allows for greats surface area for the piston to dissipate heat to the seat 24. Air flow a0 being split also allows for cooling to be equally distributed on opposite sides of the pistons.

FIG. 3C is a detailed bottom section view of the engine module showing the air flow a1 through stationary piston 23 and through piston skirt 22. The difference in height between port 22a and 22b can be observed to illustrate air flow a1 entering the compression chamber first, then a2. The exhaust port 31e is closed by the piston skirt except for when piston 22 is near BDC.

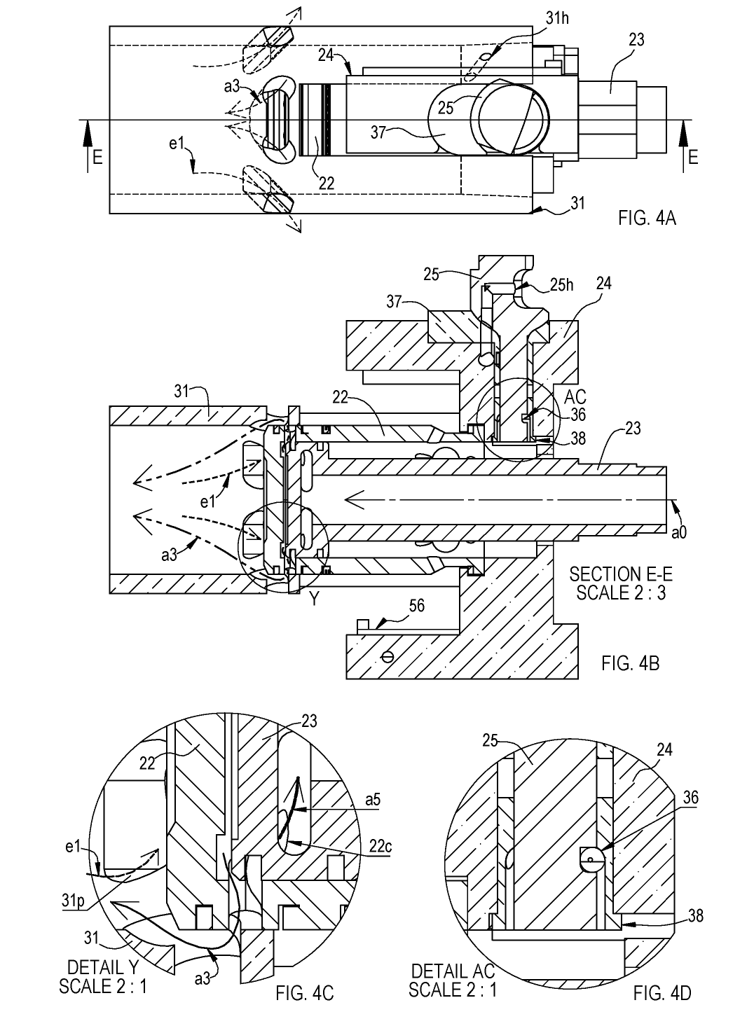

FIG. 4A is a side view of the engine module with the piston assembly positioned at about BDC. The intake flow a3 is being transferred to the combustion chamber, and is curved away from the exhaust e1 exiting the combustion chamber the opposite directions. The sides of the transfer port face each other and narrows at the end to better channel the intake charge away from the exhaust e1. The piston 22, the follower bearing 37, the follower 25 can be seen located at about BDC within cylinder 31 and over stationary piston 23. The hole 31h is adapted to squirt oil both inside and out of piston 22.

FIG. 4B is a section view of the engine module showing piston 22 near BDC. The air intake is squeezed out of the compression chamber into the combustion chamber as in a3. This is done after the exhaust e1 partially started to exit the combustion chamber. This figure also illustrates the hydraulic fluid passages that end at cavity 25h.

FIG. 4C is a detailed section view of the engine module showing air flow movements within the chambers. A pressure zone 31p is used to further force the transferred charge a3 away from the exhaust e1. Zone 31p works like a ventury choke zone to increase the pressure there while leaving a lower pressure zone near TDC for the transferred charge a3 to go fill. The transfer port 22c opens up slightly towards the ports in the stationary piston 23 as piston 22 is near BDC. Charge a5 rushes back into piston 23 when the pressure in the combustion chamber is greater than that allowed by the manufacturer. Air flow a5 flows back to the intake cavity in piston 23 when the engine reaches an excessive speed, leaving less time for the exhaust e1 to exit the combustion chamber. Therefore, less charge enters the combustion chamber which prevents the engine from over speeding. At the same time the compression ratio is increased, which creates more power with less fuel. In a scenario where the operator presses and holds down on the gas pedal, the engine will speed up and increase its compression ratio and produce more power. As the speed increases so will the compression ratio. Therefore the transfer port 23c will start to cough up intake charge back to the intake port because of the lower pressure zone in the intake tube within piston 23 as opposed to the higher pressure in the combustion chamber. Therefore, some of the intake charge loop around from the compression chamber and back to the intake passage within piston 23. This causes the engine to use less fuel at high RPM and at high compression ratio, all while preventing the engine from over speeding and explode. During normal operation, the compression ratio of the charge being compressed in the compression chamber, the timing of the transfer port to the combustion chamber being open first before port 22c is open towards the intake port within piston 23 to allow flow a5 to loop back, the direction of the initial force and momentum of the intake charge being pushed into the combustion chamber, these cause the charge to enter the combustion chamber first. The flow a5 occurs when enough pressure is built up within the combustion chamber that can overcome the charge momentum of flow a3.

FIG. 4D is a detailed section view of the follower locking mechanism. Follower 25 is inserted from one end into the piston seat 24; then a bushing 38 is inserted into the other end; then a locking key or a plurality of ball bearings 36 is inserted in between the bushing 38 and a groove 25g in the follower 25. Then the follower is twisted back to a working position while blocking the ball bearings from falling off. The cam in turns prevents the follower 25 from turning back to the position where the ball bearings can fall off. This preferred embodiment is ideal for less complexity, frictionless operation and locking procedure for safety. A nut to screw in the follower and other locking mechanism to lock the nut itself in can be used as an alternative.

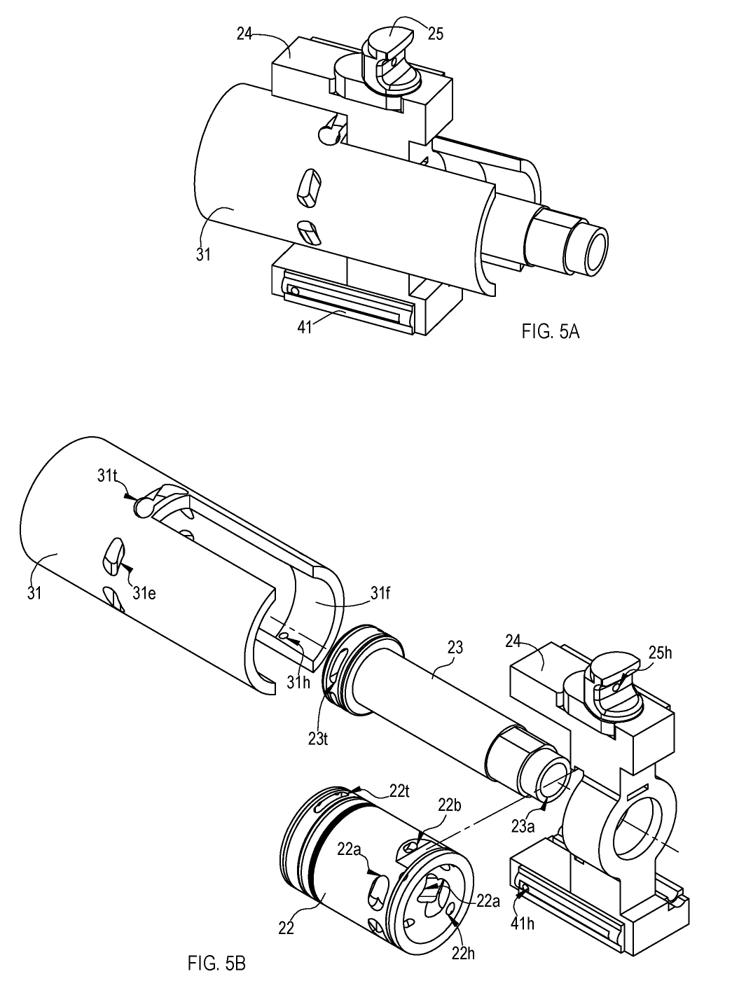

FIG. 5A is an isometric view of the engine module showing reaction bearing 41 mounted on the hydraulic bearing arm of the piston seat 24. The follower 25 is positioned at about TDC within cylinder liner 31.

FIG. 5B is an exploded view of the engine module, showing cylinder module 31, exhaust ports 31e, transfer ports 31t, the lubrication passageway 31h to squirt oil to the pistons, chamfer bottom 31f to ease with piston installation. Intake transfer ports 23t on the stationary piston 23 are used to split the intake flow from 23a to aid in cooling the pistons symmetrically. At least one transfer port 22a is used to transfer air from the ports 23t, to the compression chamber. At least one transfer port 22t is used on the piston 22 to transfer air to the combustion chamber. These ports are symmetrically positions on the opposite sides of the pistons to ease with distributed cooling of these components. Holes 22h are used to transfer oil to aid with sidewalls lubrication. Hole 41h is used to lubricate the reaction bearing on the hydraulic arm of the piston seat 24. Hole 25h is used to form hydraulic bearing between the cam and follower.

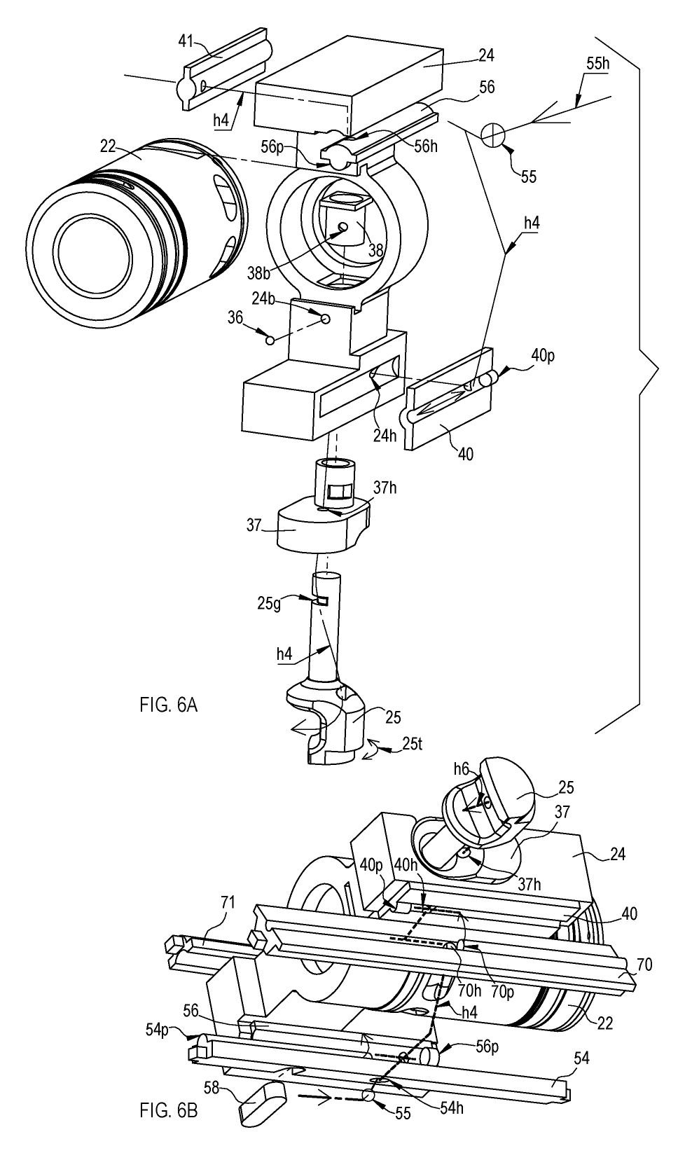

FIG. 6A is an exploded view of the piston assembly for the modular engine. This figure illustrates how the components are mounted together. The follower 25 is inserted through bearing 37, then through the follower arm of the piston seat 24. The bushing 38 is inserted into the follower arm of the piston seat while aligning hole 38b with hole 24b to allow ball bearing 36 to go through and lock these components with the follower. The follower 25 is twisted as in 25t to allow the ball bearing 36 in its groove forming a lock mechanism. The piston 22 is slid into the piston seat 24. The flat face on the piston 22 and on the piston seat prevents the piston from turning. This in turns prevents the piston rings from turning during operation. The action bearing 40 transfers the load of the follower to the engine block. This load is transferred like a foot on a ski wherein the follower is like a foot pushing on about the center of the bearing 40 which is like a wide ski. As the follower pushes down on one side of bearing 40, there is a reaction force on the opposite side which is canceled by bearing 41. The protrusion 56p on bearing 56 is adapted to squeeze oil through hole 56h to lubricate bearing 41. Protrusion 56p serves like a syringe sucking oil 55h through oil check valve 55, to the hole in bearing 40. The line h4 is the oil path. Protrusion 40p is adapted to prevent the hydraulic oil from escaping. The oil then goes through hole 24h, then to 37h to exit through the center of the follower.

FIG. 6B is another exploded view of the piston assembly showing the two halves of the hydraulic pump bearings 56 and 54 when closed, formed a syringe like component with oil intake sucked in, going through check valve 55, then squeezed out through hole 54h towards hole 70h to transfer forces from the hydraulic pump side of the seat 24 to the follower support side of the seat. The protrusions 54p and 56p and their respective cavities form a syringe like component pushing oil towards another syringe like component made of two halves 70, and 40. The protrusions 70p and 40p form a closed syringe like component where hydraulic fluid within applies equal pressure in all directions to balance the forces involved. Bearing 71 is mated with bearing 41 to counter the reaction forces of the follower on opposite side of the piston seat. Bearing key 58 is used to lock bearing 54 into position on the engine block. This preferred embodiment is one of the ways that the piston may be connected to the follower by providing a frictionless mechanism while powering the follower. The piston seat may be adapted to function without a hydraulic pump. At least one other surface area may be used to replace the syringe like components.

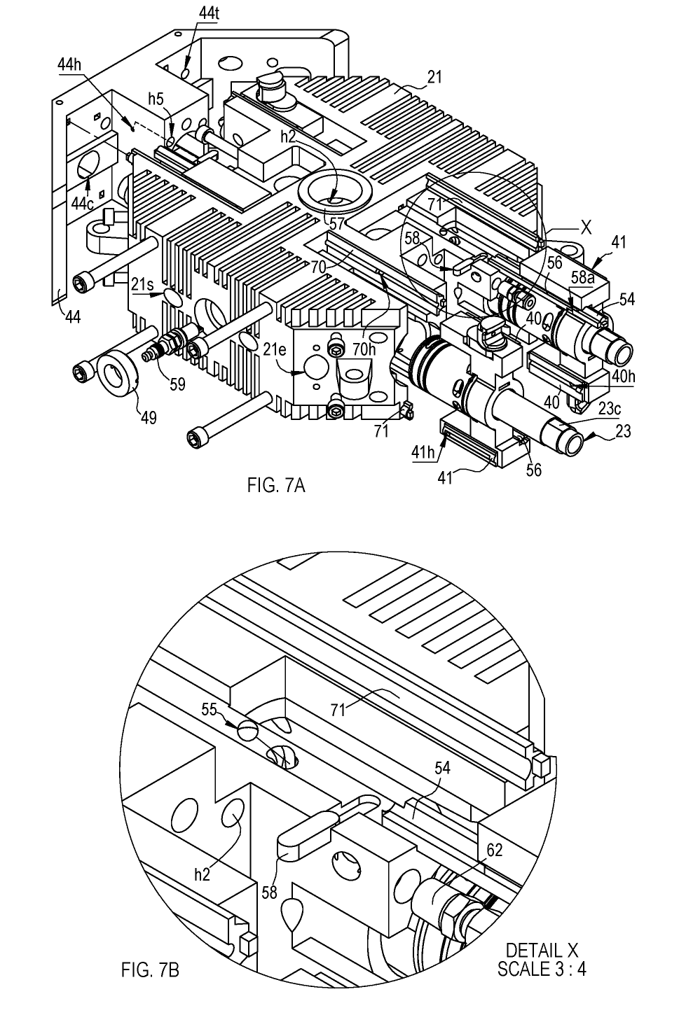

FIG. 7A is an exploded view of multiple engine modules sharing a single engine block 21. A cylinder bottom 44 is used to secure the piston assemblies to the engine block. Surface 23c is mated with surface 44c to prevent the stationary pistons from turning. This setup will in turn prevent the piston rings from turning while avoiding the transfer ports. Exhaust passage 21e is adapted to align with exhaust ports on liner 31e. Sparkplug 59 is screwed in at about the center of the block. A shaft bearing 49 goes over the sparkplug hole, while hole 21s is used to feed the sparkplug cable through. A groove 58a underneath bearing 54 is used to allow key 58 to lock the piston assembly into working position. The semi-round features on bearings 71, 70 and features on their adjacent components are there to serve as a rail to prevent sideway movements. Therefore, the load from the followers will be channeled and be forced to ride within these rails to prevent the piston skirt and seat from brushing the cylinder walls. Hole 70h goes through the engine block to feed oil to hole 40h. Line 44h represents oil passages from the center hub 57. Hole h2 faces hole h5, intersecting with 44h to squirt oil to the pistons via hole 31h. Bearing 57 is used to support rotating cam plates or flywheels.

FIG. 7B is a detailed view of the piston assembly being inserted into the engine block. First, the hydraulic check valve 55 is inserted into the engine block. Then, bearing 71 and the piston assembly are inserted into the block or cylinder liner. Then, bearing 54 goes in between bearing 56 and the engine block to form a syringe like hydraulic pump as illustrated in FIG. 7A. Bearing key 58 finally locks in bearing 54 which in turns locks in the piston assembly into working position. Cylinder bottom 44 prevents key 58 from getting out. Hole h2 in this figure faces hole h5 and goes straight towards the center of the block. Oil fitting 62 feeds oil to the hydraulic pump and to hole h2 at the center of the block to be distributed to all moving components.

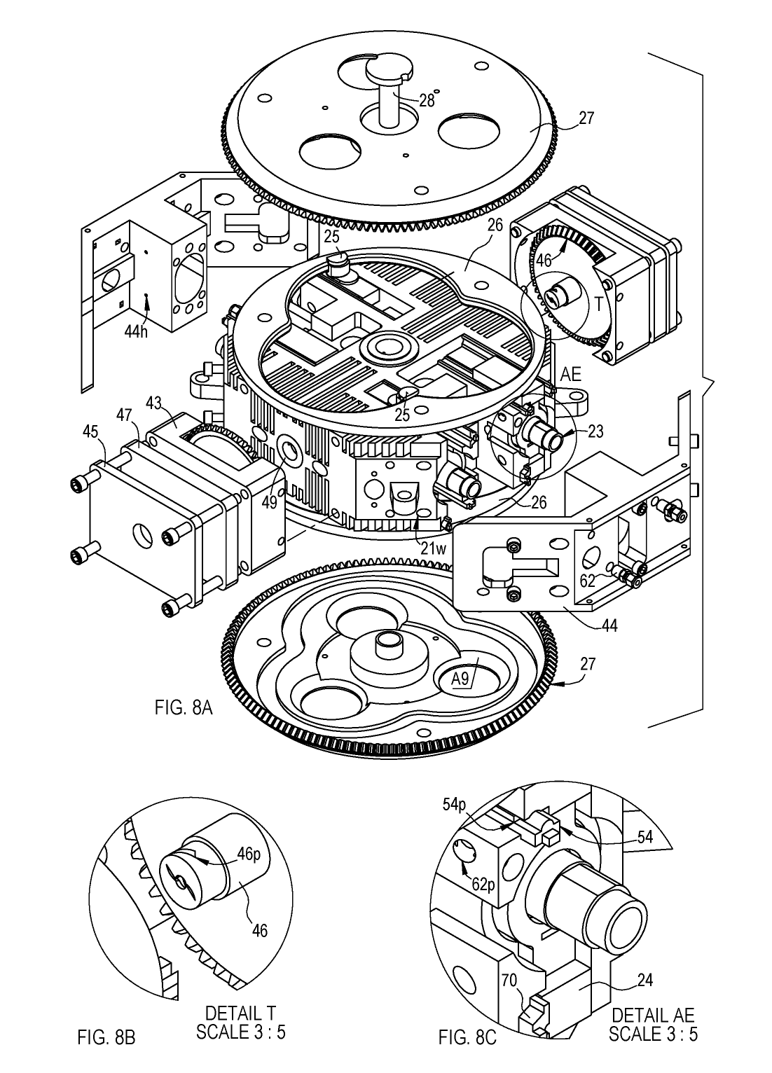

FIG. 8A is an exploded view of a rotary engine showing four engine modules within the engine block. Two followers 25 interact with the top cam 26 and two other followers underneath interact with the cam underneath 26. The cams are mounted on their respective flywheel 27. In the preferred embodiment, a bolt 28 is used to hold both flywheels in place as they turn in opposite direction. This configuration allows for engine reactive torque to be substantially canceled. In other configurations, the followers may be adapted to push both flywheels in the same direction. However, this would result on a change of the respective gears. In the preferred embodiment, the gears on engine shaft 46 engage the gears on flywheel 27. The shaft 46 is bolted into the engine block along with the oil pump 47, case cover 45. Bearing 49 is used to facilitate frictionless operation of shaft 46. Cylinder bottoms 44 are used to bold stationary pistons 23 in place. Redundant oil fittings 62 are used to connect the oil gallery in the engine block with an external oil filter. Cavity A9 is used as a fan to help cool down the engine. Holes 21w go straight through the engine block which can optionally be used for water cooling. The isolation of these holes helps to isolate any water leaks from damaging the internal components.

FIG. 8B is used to illustrate a simple oil pump 46p carved into shaft 46. This pump helps to counter the axial forces exerted on the shaft. This pump also pressurizes the oil between the shaft and its bearings to increase its durability.

FIG. 8C is a detailed view of the engine module inserted within the engine block and positioned at about BDC. This figure illustrates the hydraulic pump 54 is fed by oil to and from the center oil gallery. Hole 62p is used to feed 31h to squirt oil to lubricate the pistons. Piston seat 24 rides on rail like bearing 70. The tapered shape is used to keep the bearing from moving sideways.

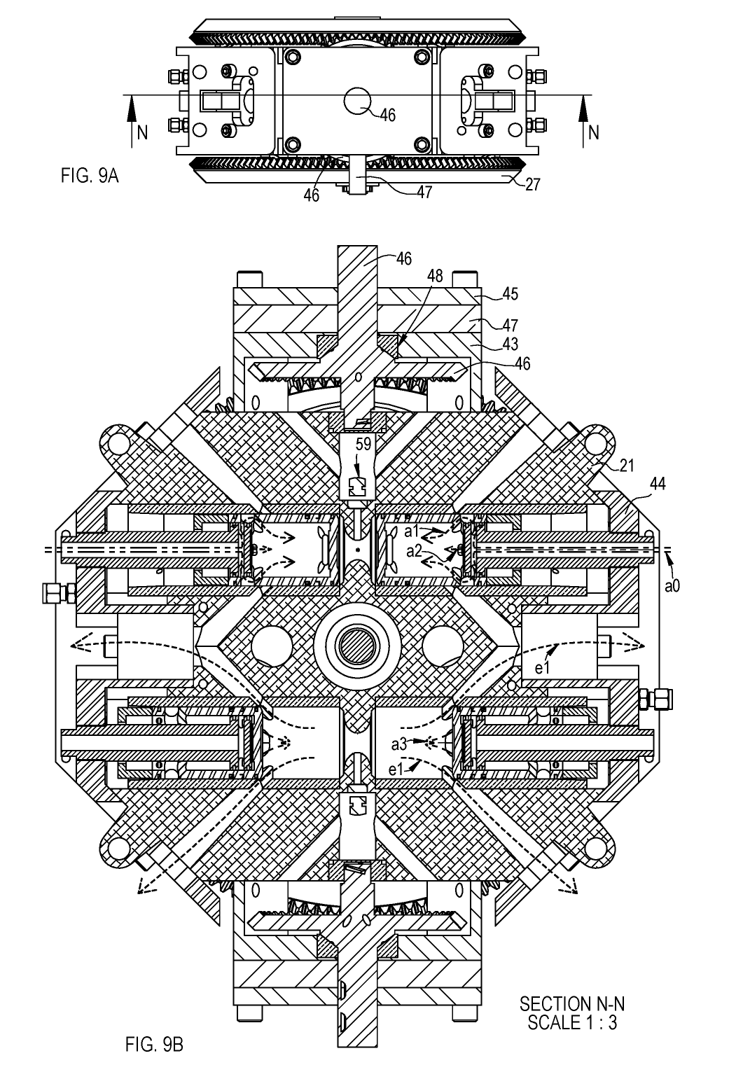

FIG. 9A is a front view of the rotary engine comprising of 4 engine modules.

FIG. 9B is a section view of the rotary engine showing shaft 46, shaft cover 45, engine pump 47, shaft support 43 and bearing 48. These components are bolted into the engine block 21. Two engine modules form one combustion chamber. Two combustion chambers form the rotary engine. When the opposed pistons of one of the combustion chambers are at TDC, the other pistons of the other combustion chamber are at BDC. The pistons on top are at TDC. Air flow a0 from a throttle body enters the compression chamber first as a1. Then air flow a2 enters second. The pistons at the bottom are at BDC. Exhaust e1 partially exits the combustion chamber first. Then, air flow a3 enters the combustion chamber. The air and exhaust flows symmetrically to cool the related components. The sparkplug 59 is positioned at the center of the shared combustion chambers. The sparkplug can be replaced with a diesel injector to turn this engine into a diesel engine or a gasoline direct injected engine. This preferred embodiment uses a throttle body carburetor for simplicity.

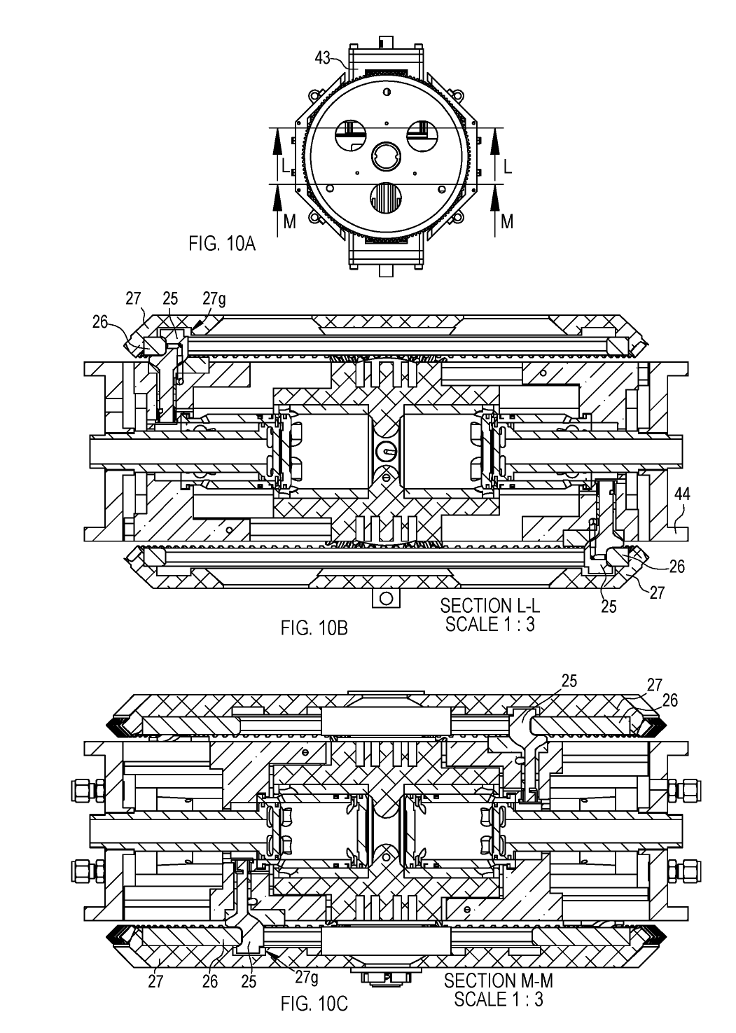

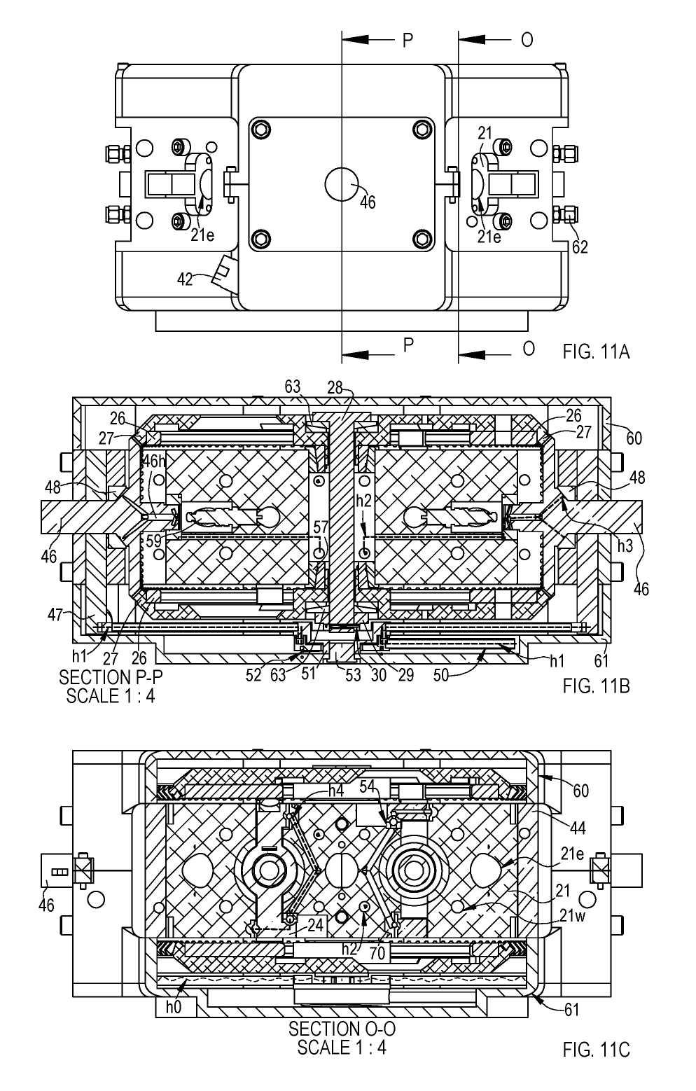

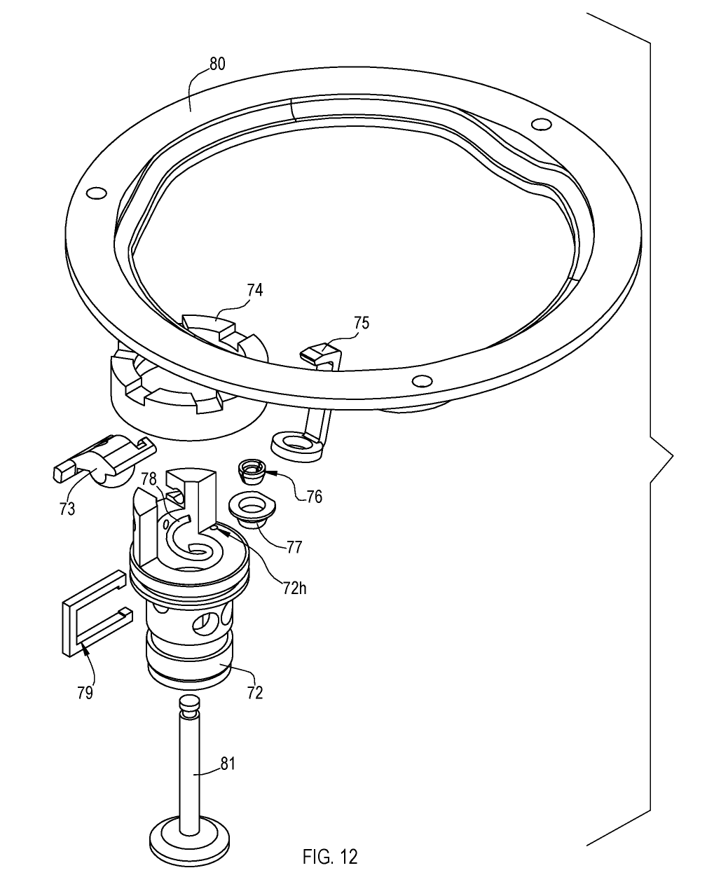

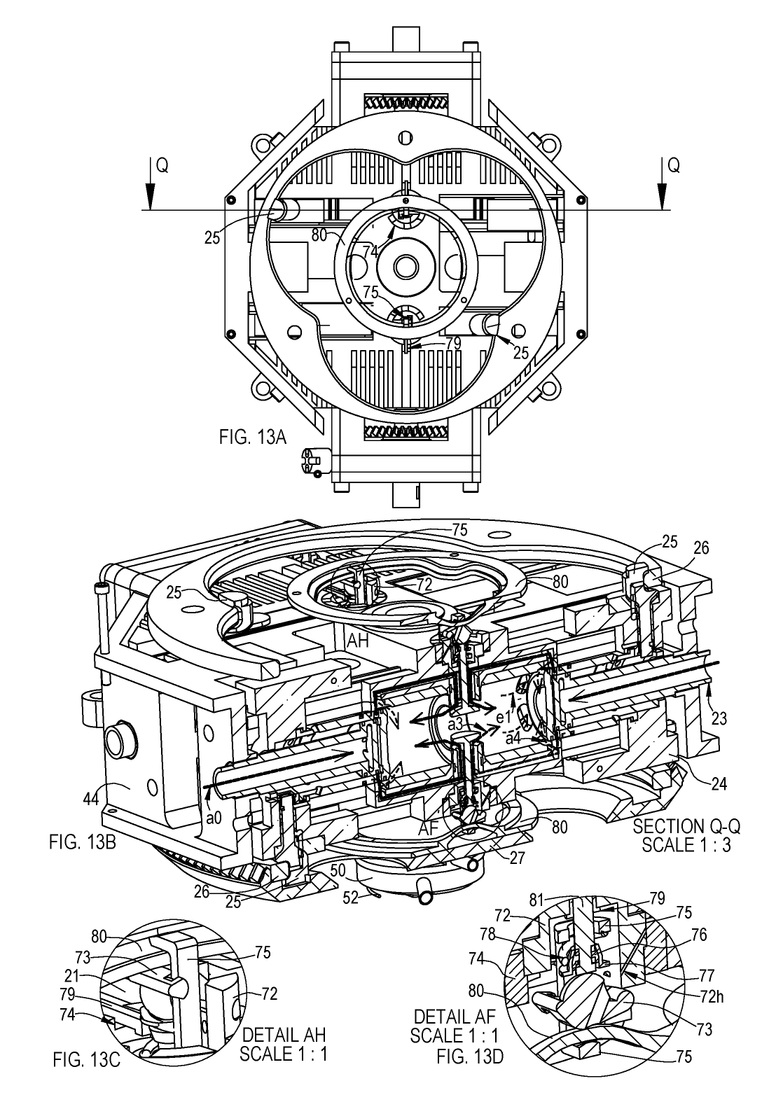

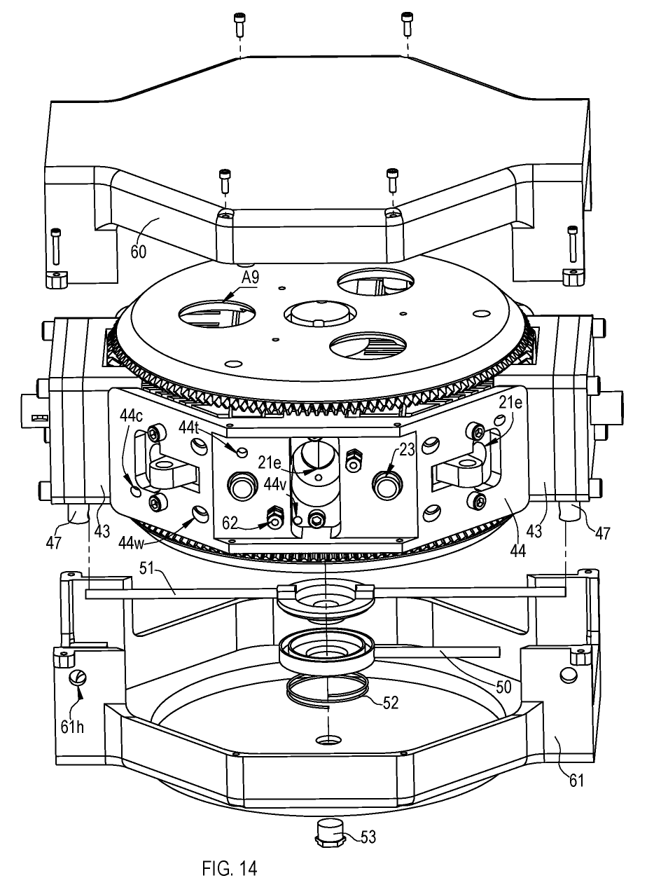

FIG. 10A is a top view of the rotary engine.

FIG. 10B is a top section view of the rotary engine illustration the pistons at about BDC. This view illustrates how the followers 25, the cams 26, the flywheels 27, all balance each other on opposite end of the engine. Groove distance 27g prevents the follower from turning all the way around, which would cause its locking bearings to fall off.

FIG. 10C is a top section view of the rotary engine illustrating the pistons at about TDC. This view also illustrates how the followers, the cam and the flywheels balance each other on opposite end of the engine.

FIG. 11A shows a front view of the rotary engine. The exhaust ports 21e are redundant, improving air flow. An oil cap 42 is located near bottom to prevent excessive oil from being poured into the engine. This figure also illustrates redundant oil fittings 62. Each combustion chamber has its own components allowing the engine to function in case of a failure from a component associated with the other combustion chamber.

FIG. 11B is a front center section view of the rotary engine. This illustrates the axle 28 and its respective nut 29 holding the flywheels 27 in place along with their bearings 63 and 57. This figure also illustrates oil pickup head 50 sucking oil as in h1, which goes through an oil collection housing 51, towards oil pump 47. From there, oil is pumped to an external oil filter to return back to the engine block as h2 via oil fitting 62. The pump on the shaft 46 pressurizes oil h2 and pushes it underneath shaft bearing 48 as h3. Oil drain plug 53 is used during oil change. A spring 52 is used to keep pickup head 50 pressed against the collection housing. A cotter pin is used to prevent the axial nut from turning. Passages 46h illustrate the inner working of the pump within shaft 46. This also shows the sparkplug 59 positioned at the center of each combustion chamber.

FIG. 11C is a front section view of the rotary engine which shows how the hydraulic pump 54 transfers oil as in h4 towards the follower support arm of the piston seat. This figure also illustrates the oil gallery h2 within the block, the water coolant gallery 21w within the block, the exhaust 21e. This figure also illustrates the oil sump 61 and the oil level h0 within. The engine cover 60 seals up everything in conjunction with the cylinder bottoms 44 and the oil sump, forming the engine case.

FIG. 12 is an exploded view of a valve assembly that can be screwed to the engine block like a sparkplug. A valve 81 is inserted within valve body 72 which may be itself a valve guide or contain one. A cam hook 75 goes over the valve stem. A short spring 78 sits on the bottom of hook 75. A valve split key 76 goes within the groove on the valve stem where a valve spring retainer is used to secure these components in place. A rocker 73 is inserted in between the head of the valve 81 and the head of hook 75. A screw 74 is used to screw in the valve body 72 to the engine block. A locking pin 79 is used to lock the valve body into the engine block. A valve cam 80 is normally mounted on the cam plate 27. Therefore, the hook 75 has to be lifted and open a little bit to allow the cam 80 to sit in between the hook and the rocker 73. As the cam 80 turns with the flywheel 27 to about BDC, the lobes on the cam pushes down on the valve without resistance. Then, as the exhaust ports are about to be closed by the pistons, the grooves in the cam 80 pushes the heat of the hook 75 up, which in turns closes the valve 81. The spring 78 is there to simply keep the hook 75 and the rocker 73 in constant contact with the groove and lobes on the cam 80. Since the rocker 73 does not push on the spring 78, the spring does not float, hence float-less valve. Oil passage 72h is used to lubricate the valve assembly. Engine manufacturers have the flexibility to open and close the valves per their specifications, including the use of a governor which may be mounted on the flywheels to twist the valve cams to delay the valve opening intervals with engine speed. The governor may be at least one small weight pushing on a spring loaded component which actuates the valve cams on the flywheels.

FIG. 13A is a top view of the rotary engine with the valve assembly installed. The valve cam 80 operates two valves.

FIG. 13B is a sectional isometric view of the rotary engine equipped with the valve assembly. This figure illustrates two valve assemblies per combustion chamber. The air flow a0 is first transferred to the combustion chamber through the valves as in a3. Air flow a4 enters the combustion chamber later as an option. Due to the possibility that the valves may be closed too soon at high RPM, this configuration allows for any remain air intake to be pushed into the combustion chamber at the last moment.

FIG. 13C is a detailed view of the valve assembly during operation. The cam hook 75 rides the groove on the cam 80, which in turns rides over rocker 73. The valve body 72 is secured to the engine block 21 using valve nut 74 and the key 79.

FIG. 13D is a detailed section view of the valve assembly in operation. Valve 81 is actuated by rocker 73, which in turn is actuated by cam 80. Spring 78 pushes against the valve spring retainer 77 and the seat of hook 75 to keep the moving components of the valve assembly in constant contact with the valve cam 80. Oil passage 72h is used to lubricate the valve components. This engine may be configured with exhaust ports near TDC and intake ports near BDC.

FIG. 14 is an exploded view of the rotary engine inside its cover 60 and oil sump 61. A9 holes work like fan blades to help cool the engine block. Hole 44c is used to feed cables through to power the sparkplug or an injector. Hole 44v is used as a bypass air supply to the engine. This also serves as positive crankcase ventilation. The exhaust ports 21e are redundant on each side of the engine. The oil fitting 62 are redundant as well. Hole 44w allows for optional coolants to go through the block 21 to help cool the engine if necessary. Hole 44t is used to mount a bearing level sensor device. The head of the device is pressed down by the piston seat when internal bearings levels are too low. As the piston seats reach BDC, any slack within the cam follower bearings, and the axial bearings will cause the piston seat to get closer to the cylinder bottom 44. The oil collection housing 51 works like a pipe dipped underneath oil to allow oil pumps 47 to suck oil to lubricate engine parts. The oil seeker head 50 rotates 360 degree by gravity. The spring 52 presses against the oil sump and head 50 to keep housing 51 in constant contact with head 50. The oil drain nut 53 further secures oil collector housing 51 to the oil sump. Hole 61h is used to route oil to an external oil filter.

### BACKGROUND OF THE INVENTION

A conventional engine has a piston rod which is connected to a shaft. This setup causes energy to be wasted in form of heat and NOx while the piston is near top dead center. By using a cam and follower design to spin the shaft, these problems are mostly eliminated. However, conventional cam and follower engine designs have not been successful due to in part problems related to roller bearing followers whereas the force of the piston is applied on the cam using a small contact point on the roller bearing and cam surface. A better design is necessary to address this issue. This cam and follower design allows for a cam and follower with identical adjacent surface areas. Therefore, the force of the piston can be applied on the cam using a greater surface area than that of a roller bearing follower.

1. An apparatus for translating reciprocal motion into rotational motion using a cam and follower comprising:
a cam groove with an endless loop cam profile
at least one follower
wherein the cam groove with an endless loop cam profile is traced from a plurality of interconnecting circles forming an endless groove, wherein the surface of the at least one follower is a circle that shares the same axis and radius with the interconnecting circles forming the cam groove with an endless loop cam profile, wherein the surface of the at least one follower is located near its own axis and pivots back and forth following the adjacent surface of the cam groove with an endless loop cam profile, wherein the round face of the follower remains in constant contact with adjacent round faces of said cam groove with an endless loop cam profile to distribute forces involved from top dead center TDC and back.

2. An apparatus according to claim 1, wherein the cam groove with an endless loop cam profile is made of three interconnected circles to allow the at least one follower to be near top dead center TDC when another one is near bottom dead center BDC.

3. An apparatus according to claim 1, a two-stroke engine using the cam and follower comprising:
a) a cylinder
b) a movable piston working within said cylinder
c) a stationary piston working within the said movable piston
d) a piston seat attached to the movable piston, and carrying a follower
e) a cam component adapted to turn a shaft
wherein at least one transfer port is located near bottom dead center (BDC) in relations to the movable piston in the cylinder, wherein at least one exhaust port is located near bottom BDC, wherein at least one transfer port is located on the side and near the movable piston crown, wherein at least one transfer port is located on the side and near bottom of the moving piston skirt, wherein at least one transfer port is located on the sides and near the stationary piston crown, wherein air passages are located within the stationary piston to allow air or charge to enter the rear compression chamber underneath the movable piston via said transfer ports on the stationary piston and the ports near bottom of the movable piston skirt, wherein the ports allowing the charge into the rear compression chambers are open when the movable piston is near Top Dead Center (TDC), wherein the charge in the rear compression chamber is compressed as the movable piston travel towards BDC when the ports used to allow the charge in is now closed, wherein the transfer ports near movable piston crown are now open to allow the compressed air from the rear compression chamber to enter the combustion chamber, wherein the movable piston move towards TDC and close its ports to compress the charge and ignite to push on the piston seat, wherein the piston seat houses at least one follower which in turn pushes on the adjacent cam to spin the supporting flywheel and the shaft.

4. A two-stroke engine according to claim 3, wherein the said ports near bottom of the movable piston skirt are closed and the transfer ports on the stationary piston are closed and a check valve is mounted on the stationary piston wherein the charge from a throttle body goes through the stationary piston passages and through the check valve to enter the rear compression chamber.

5. A two-stroke engine according to claim 3, wherein a valve assembly is used near TDC and actuated by a valve cam, wherein the charge entering the stationary piston is transferred to the rear compression chamber where ports on the piston skirt allows the compressed charge to travel through passages and to the said valve assembly.

6. A float-less valve assembly that can be screwed into an engine comprising:
a) a valve
b) a valve body
c) a rocker
d) a valve nut
e) a spring
f) a spring retainer mechanism
g) a cam hook
h) a valve cam
Wherein the valve is inserted into the said valve body which can be screwed to the engine block or with the aid of the said valve nut, wherein the rocker is mounted on the valve body and being actuated by the valve cam, wherein the said cam hook is adapted for the said spring to sit on it and the said spring retainer mechanism to push against the valve stem and the base of the said hook to allow the head of the said cam hook to ride in a groove of the said valve cam, wherein as the said valve cam rotates with an engine rotating shaft, the lobes presses down on the rocker which presses down on the valve, wherein the groove on the said valve cam lifts up the said valve via said cam hook, wherein the said spring and retainer mechanism are used to keep the said valve cam in constant contact with the said rocker and said cam hook, wherein the said valve goes up and down with the said valve cam.
